(19) United States
(12) Patent Application Publication
(10) Pub. No.: US 2013/0015223 A1
(43) Pub. Date: Jan. 17, 2013

(54) VEHICLE CLOTHING HANGER

(71) Applicant: Donald FLEMING, Indian Land, SC (US)

(72) Inventor: Donald FLEMING, Indian Land, SC (US)

(21) Appl. No.: 13/179,821

(22) Filed: Jul. 11, 2011

(51) Int. Cl. B60R 7/10

(52) U.S. Cl. 224/545

(57) ABSTRACT

A clothing hanger system includes a rod, a handle, and an attachment device configured to attach to a fixed stable point such as a head restraint stem. The attachment device may be slipped around and onto the stem and fixed into place by engaging opposing portions of attachment device into a press fit against the stem. The rod may project outwardly therefrom allowing clothing to be hung freely from the rod.

### BACKGROUND OF THE INVENTION

The present invention generally relates to clothing accessories, and more particularly, to a clothing hanger.

The rear seat compartment area of a vehicle is not conducive to a traveler's packing needs. Clothing hung by some current systems may be subject to the compartment interior where the clothing may wrinkle. Typically, clothing may also be hung by a window obstructing a driver's view.

In some cases, the rear seat compartment installation of a long bar clothes hanging system with loops on the opposite ends are often suspended from the factory installed automobile hooks located on opposite sides of the vehicle. This type of clothes bar is useful if the hooks are present and are capable of supporting the added weight of the clothing. Yet, this system occupies the entire rear seat space, may obstruct driver visibility and can be inconvenient to install, uninstall, and store on a routine basis.

Other types of vehicle clothing hangers that have been proposed are subject to many of the same shortcomings. For example, U.S. Pat. Nos. 2,532,909 and 2,617,571 to Hart disclose hanger bars that extend across the entire width of the vehicle. The device shown in U.S. Pat. No. 2,526,285 to Schuyler is equally unsatisfactory because of the need for a special mounting bracket. Although the devices disclosed in U.S. Pat. No. 3,002,666 to Silverman, 3,275,161 to Robertson and U.S. Pat. No. 3,708,093 to Toms can be hung on a single automobile hook, all of these devices may lack versatility and are unsatisfactory in a number of additional aspects. None of the devices disclosed in the aforementioned patents appears to have met with significant commercial success, in large part because of the shortcomings mentioned above.

As can be seen, there is a need for an apparatus that allows a user to securely hang clothing in passenger spaces avoiding wrinkling of clothes. Additionally, it can be seen that a need exists for an apparatus that stores clothing in a vehicle without obstructing a rider's view.

### SUMMARY OF THE INVENTION

In one aspect of the present invention, a clothing hanger system comprises a rod portion, a stop end coupled to a first end of the rod portion, and a pair of blocks configured to open from and close against one another in relationship to a linear rotation of the rod portion.

In another aspect of the present invention, clothing hanger system configured to couple to a stable point comprises a linear rod, a handle coupled to a first rod end, a second threaded rod end, a fixed position block coupled to an intermediate point of the linear rod, and an adjustable position block coupled to the second threaded rod end. The linear rod is disposed to project orthogonally from the stable point. The rod is configured to rotate and press fit the stable point between the fixed position block and the adjustable position block.

These and other features, aspects and advantages of the present invention will become better understood with reference to the following drawings, description and claims.

### BRIEF DESCRIPTION OF THE DRAWINGS

FIG. 1 is a perspective view of a clothing hanger in use according to an exemplary embodiment of the present invention;

FIG. 2 is a perspective view of a clothing hanger according to an exemplary embodiment of the present invention;

FIG. 3 is a side plan view of the clothing hanger of FIG. 2; and

FIG. 4 is a cross-sectional view taken along the line 4-4 of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Various inventive features are described below that can each be used independently of one another or in combination with other features.

Broadly, embodiments of the present invention generally provide a clothing hanger adapted for use within a vehicle interior and configured to allow clothing to hang substantially unobstructed. For example, exemplary embodiments according to the following disclosure may be employed within automobile interiors and configured for attachment to pre-existing elements of the interior. While the following is described for use within automobiles, it will be understood that aspects of the disclosure may be employed in other vehicles, for example, aircraft, trains, and water vessels. Exemplary embodiments of the present invention, may, in one aspect, allow multiple garments to be hung parallel to the front and rear seats of a vehicle without interfering with a driver's visibility. The garments may hang wrinkle free and be easy to reach during interim stops.

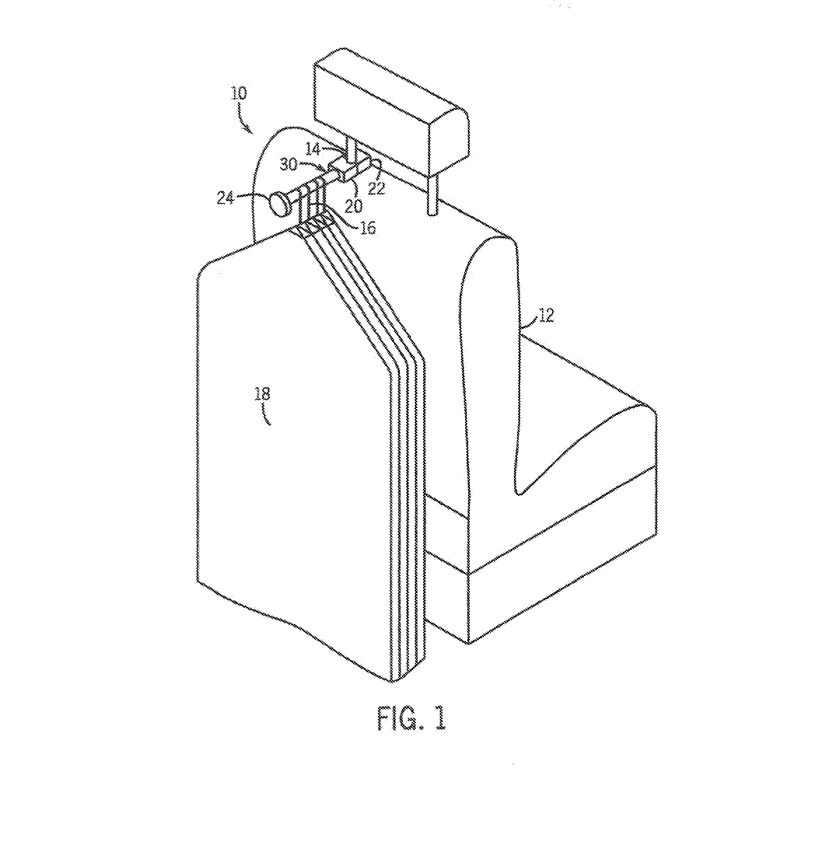

Referring to FIG. 1, an exemplary embodiment of a clothing hanger system 10 is shown. The clothing hanger system 10 includes a rod portion 30, a stop end 24, and a pair of attachment devices 20 and 22. In an exemplary use, the clothing hanger system 10 may be configured for removable attachment to a pre-existing stable point, for example, a head restraint stem 14 of seat 12. When attached to the seat 12, the rod portion 30 may project substantially Orthogonally and outwardly from the head restraint stem 14. The stop end 24 may be coupled to an end of the rod 30 opposite of the attachment devices 20 and 22. In one aspect, the stop end 24 may also be configured as a handle for rotating the rod portion 30. The stop end 24 may be disc shaped including a larger diameter than the rod portion 24. Clothing 18 may hang freely and unobstructed from hangers 16 placed onto rod portion 30.

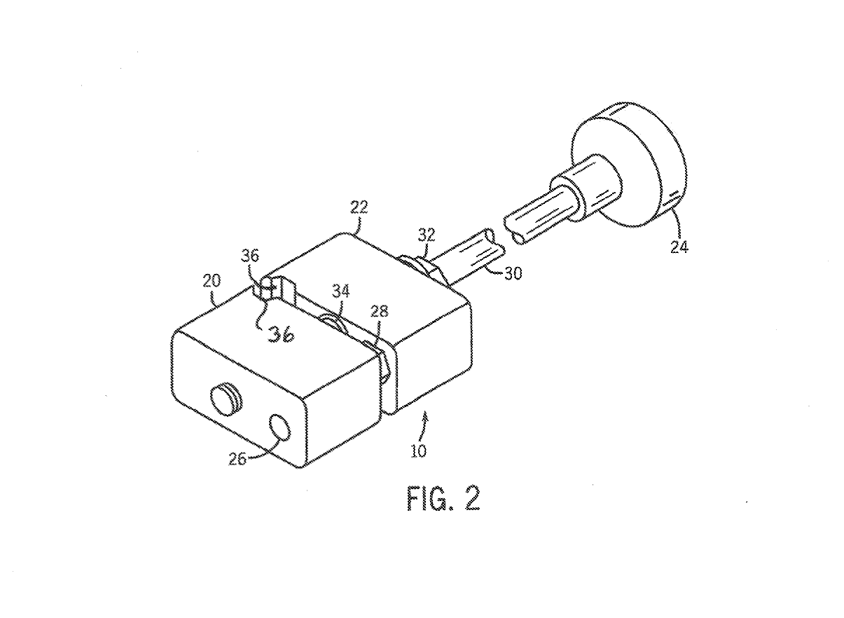

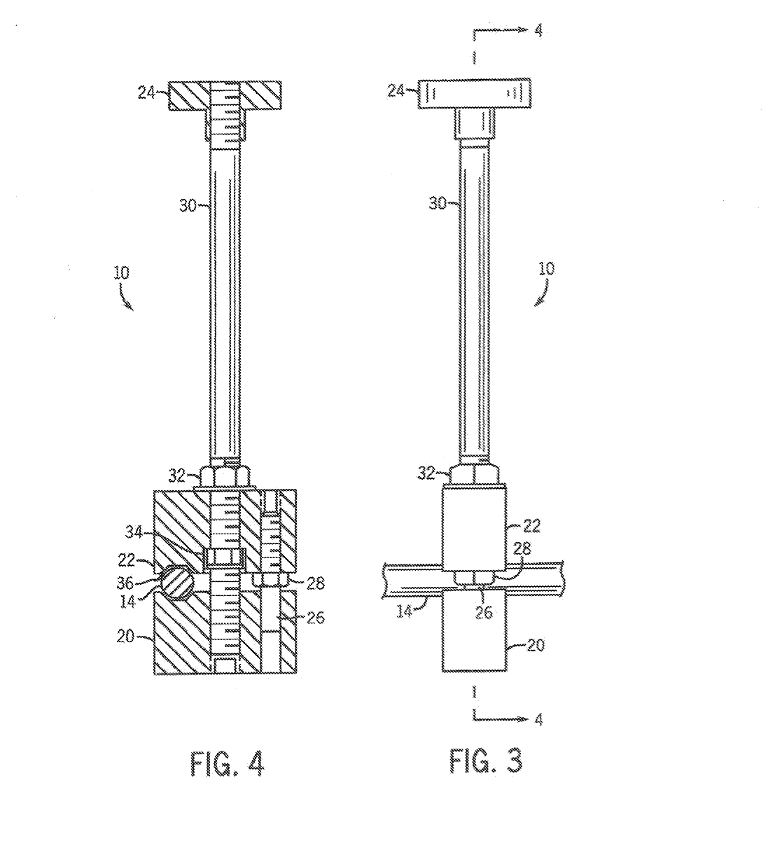

Referring now to FIGS. 2-4, various views of the clothing hanger system 10 are shown. The rod portion 30 may be a rigid, linear, generally round rod with a diameter sized to accommodate hanger hooks. The rod portion 30 may include a length configured to accommodate multiple wire or plastic hangers holding clothing. For example, the rod portion 30 may be a threaded rod steel approximately 7 to 8 inches long.

The attachment devices 20 and 22 may be, for example, a pair of vice jaw blocks coupled to the rod portion 30 configured to open and close in relationship to a linear rotation of the rod portion 30. The attachment devices 20 and 22 may also be referred to as blocks 20 and 22 respectively. The blocks 20 and 22 may have a resistance to deformation from hot and cold temperatures. For example, the attachment devices 20 and 22 may be made from 1″ block aluminum or 1″ sheet type #1 PVC. In one exemplary embodiment, each block 20, 22 has a recess 36 disposed to oppose each other on inwardly facing walls of the respective blocks and may form a substantially circular or hexagonal cavity when the blocks 20 and 22 are juxtaposed into a closed, press fit position against the stem 14. The block 22 has a drilled hole to accept the rod portion 30. A stop 32 disposed on an outer rod side of the block 22 and a stop 34 disposed on an inner rod side of the block 22 may hold the block 22 in a fixed position intermediately along the length of the rod portion 30. A guide pin 26 may be threaded into the block 22 on one side of the pin, up to a mid-point at stop 28. The guide pin 26 may also have a non-threaded shaft portion on the other side of stop 28. The guide pin 26 may be inserted into a threaded hole of block 22. The non-threaded side of guide pin 26 may be positioned to protrude in a direction parallel to rod 30. Block 20 may have a threaded hole positioned to receive the extended portion of rod 30 and a drilled hole to receive the non-threaded extending length of guide pin 26. By the clockwise rotation of rod 30, device 20 may be adjustable to travel closer along the linear helix of the threaded portion of the rod 30 toward device 22.

In operation, a user may attach the clothing hanger system 10 to a head restraint stem 14 by positioning the recessed indentations 36 of respective blocks 20 and 22 to slip around the head restraint stem 14. The clothing hanger system 10 may be oriented so that the rod portion 30 is positioned generally orthogonal from the stem 14. The user may then rotate the stop end 24 engaging the threaded portion 30 into the threaded hole of block 22 and through block 20 until the recessed indentations 36 engage the head restraint stem 14. The stop end 24 (handle) is rotated to manually torque the recessed indentations 36 and blocks 20 and 22 into a, secured, press fit with the stem 14. With the rod portion 30 projecting outward and away from the stem 14, the user may hang up to approximately 15 lbs of clothing parallel to a back face of a seat with the clothing hanging freely from touching wrinkling surfaces. Hanger hooks may be prevented from slipping off the rod portion 30 by encountering the stop end 24 on a free end of the rod portion 24.

It should be understood, of course, that the foregoing relates to exemplary embodiments of the invention and that modifications may be made without departing from the spirit and scope of the invention as set forth in the following claims.

What is claimed is:

1. A clothing hanger system, comprises:
a rod portion;
a stop end coupled to a first end of the rod portion; and
a pair of blocks configured to open from and close against one another in relationship to a linear rotation of the rod portion.

2. The clothing hanger system of claim 1, further comprising a recessed indentation disposed on at least one of the blocks.

3. The clothing hanger system of claim 2, wherein both blocks include a recessed indentation, each indentation disposed to opposingly face the other indentation.

4. The clothing hanger system of claim 1, further comprising a guide pin disposed to project from one of the blocks and positioned to be received by a hole disposed on the other block in relationship to the linear rotation of the rod portion.

5. The clothing hanger system of claim 1, wherein the stop end includes a diameter larger than a rod portion diameter.

6. A clothing hanger system configured to couple to a stable point, comprising:
a linear rod;
a handle coupled to a first rod end;
a second threaded rod end;
a fixed position block coupled to an intermediate point of the linear rod; and
an adjustable position block coupled to the second threaded rod end, wherein
the linear rod is disposed to project orthogonally from the stable point, and wherein the rod is configured to rotate and press fit the stable point between the fixed position block and the adjustable position block.

7. The clothing hanger system of claim 6, further comprising opposing recessed indentations on the fixed position block and adjustable position block, wherein the recessed indentations are positioned to surround and press fit against the stable point.

8. The clothing hanger system of claim 6, wherein the handle includes a diameter larger than a rod diameter.
